(19) United States
(12) Patent Application Publication
(10) Pub. No.: US 2020/0241994 A1
(43) Pub. Date: Jul. 30, 2020

(54) Global File Flow Forecasting System and Methods of Operation

(71) Applicants: ROGER MARCH, CAMPBELL (US); SIARHEI LOBACH, CAMPBELL, CA (US)

(72) Inventors: ROGER MARCH, CAMPBELL (US); SIARHEI LOBACH, CAMPBELL, CA (US)

(21) Appl. No.: 16/221,169

(22) Filed: Jan. 30, 2019

(51) Int. Cl. G06F 11/34; G06F 9/50; G06F 9/48; G06F 16/18; G06F 16/17; G06F 16/178

(52) U.S. Cl. CPC G06F 11/3442; G06F 11/3419; G06F 11/3495; G06F 9/5077; G06F 9/505; G06F 9/5033; G06F 2201/815; G06F 16/1873; G06F 16/1734; G06F 16/178; G06F 2209/5019; G06F 2209/508; G06F 2209/501; G06F 9/4881

(57) ABSTRACT

Dataflow Meteorology Aggregation monitors data deployment across a global 24×7 workflow. File operation metrics are aggregated at regional server peers over a daily cycle of computation. The system forecasts demand for resources and stages prepositioned virtual machines in anticipation of demand to ameliorate latency. Patterns of demand for dynamic or invariant data among regional timezones over the course of a workday are profiled. A data centric workflow is optimized by tracking file operations during a 24-hour global computation cycle. Each file operation is monitored with location, file identifier, and location by date-time. Critical paths through the workflow are traced and bottlenecks identified. On a work day cycle, processor images and file contents are pre-positioned for anticipated demands to reduce searching for and transmission of portions of data sets. Peer delegated subspace servers are assigned resources and assigned to network node where they can perform with least latency.

### CROSS-REFERENCE TO RELATED APPLICATIONS

None.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### Technical Field

The disclosure relates to optimization of a computer system, specifically, reduction of latency in globally distributed file and processor resources.

### BACKGROUND

As is known, globally distributed Information Technology resources are utilized in different ways as workflow follows the sun. Rather than hand offs among localized industrial-type day shifts, swing shifts, and night shifts, intellectual property teams which span meridians in longitude to continuously deploy a plurality of “fresh eyes” to optimize each critical path in project management.

As is known, complex workflows utilize workspaces which contain related files. Various means such as but not limited to version tracking enable recordation of meta data about file components. For the purpose of this application we will refer to file extents but our meaning is inclusive of but not limited to blocks, bytes, records, binary images, contents, segments, sectors, cylinders, compressed and uncompressed strings, encrypted and unencrypted digital values encoded onto computer readable media and suitable for data transmission, storage, and hashing as exemplary file extents. The subject matter applies to any file system or workspace which has relatively more invariant and relatively less invariant binary objects under its measurement and control such as version-controlled source code.

What is needed is a system to track, control, forecast, and anticipate the compute resources necessary in each zone of a global workflow to reduce latency, data transmission, and to optimize the performance of a networked computer system and its users.

### BRIEF SUMMARY OF INVENTION

The invention includes a system having a plurality of regional Peer Managers coupled to a Tracker which records the existence and location of Workspaces that contain related files having invariant components created by various means and further coupled to a Virtual Dataflow Aggregator (VDA). Each Peer Manager provisions compute and storage resources to users located within a region or timezone. Global dataflow supports a 24×7 workflow through a succession of Peer Managers. File operation requests and fulfillments are reported by each regional Peer Manager over a work day cycle.

Instead of staffing a day shift, a night shift, and a swing shift, the invention progressively resources the work product to follow the sun across a globally distributed team all operating on their optimum “day” cycle time zones. The system measures files and their constituent parts across a scale of Invariance Quality in a series of workflows.

The VDA converts file operation reports into a common format and determines patterns which are likely to repeat either preceding or succeeding data flows among the regional Peer Managers.

Conventional systems cannot record the Invariance Quality (IQ) of sub-elements of files. On a regular cycle, a hypothetical profile is constructed for the following day's workfile flow. The profile is scored for accuracy at each meridian's “end of day” and IQ's are incrementally refined.

Dataflow Meteorology Aggregation monitors data deployment across a global 24×7 workflow. File operation metrics are aggregated at regional server peers over a daily cycle of computation. The system forecasts demand for resources and stages prepositioned virtual machines in anticipation of demand to ameliorate latency. Patterns of demand for dynamic or invariant data among regional timezones over the course of a workday are profiled. A data centric workflow is optimized by tracking file operations during a 24-hour global computation cycle. Each file operation is monitored with location, file identifier, and location by date-time. Critical paths through the workflow are traced and bottlenecks identified. On a work day cycle, processor images and file contents are pre-positioned for anticipated demands to reduce searching for and transmission of portions of data sets. Peer delegated subspace servers are assigned resources and assigned to network node where they can perform with least latency.

Analogous to a weather map, hot spots of file extent mobility, variance, and invariance are tracked and forecasted in their progress from East to West. Resources are then pre-positioned. Heuristics that mis-position resources are “punished” by losing influence in future.

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIG. 1-4 are flowcharts of method embodiments;

FIGS. 5A and 5B illustrates processes at a global dataflow aggregator: and

FIG. 6 is a block diagram of a processor suitable for performing a method embodiment of the invention.

FIG. 7 is a block diagram of a system embodiment,

### DETAILED DESCRIPTION OF INVENTION

The patentable subject matter of the application applies to apparatus and methods which optimize the performance of a computer system distributed globally with time-shifting of workfile flows to match local time of day and day of week project prosecution.

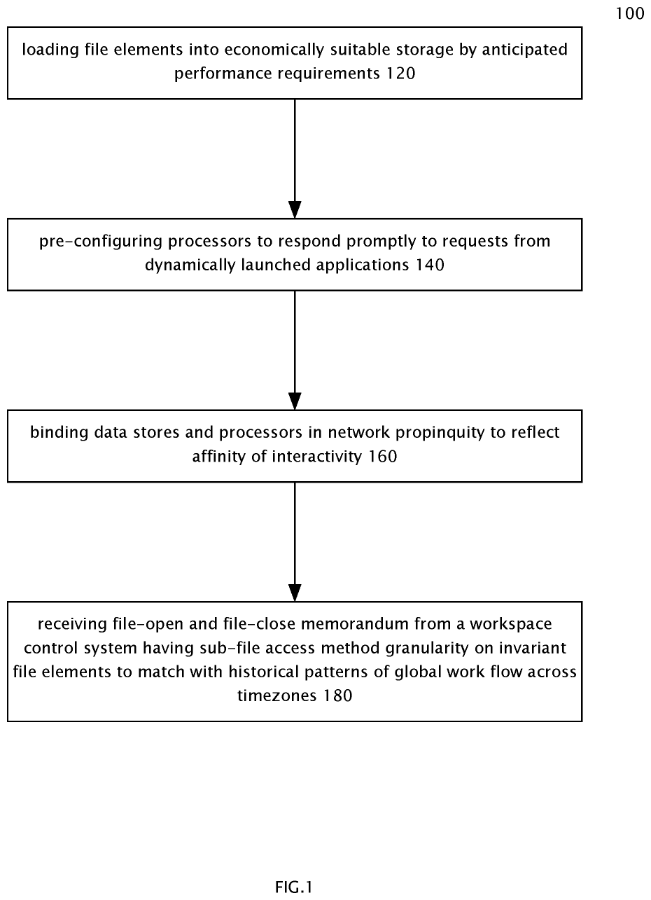

FIG. 1 illustrates one aspect of the invention is a method 100 of optimizing performance among a plurality of servers networked to storage apparatuses having at least the steps: loading file elements into economically suitable storage by anticipated performance requirements 120; pre-configuring processors to respond promptly to requests from dynamically launched applications 140; binding data stores and processors in network propinquity to reflect affinity of interactivity 160; and receiving file-open and file-close memorandum from a workspace control system having sub-file access method granularity on invariant file elements to match with historical patterns of global work flow across timezones 180.

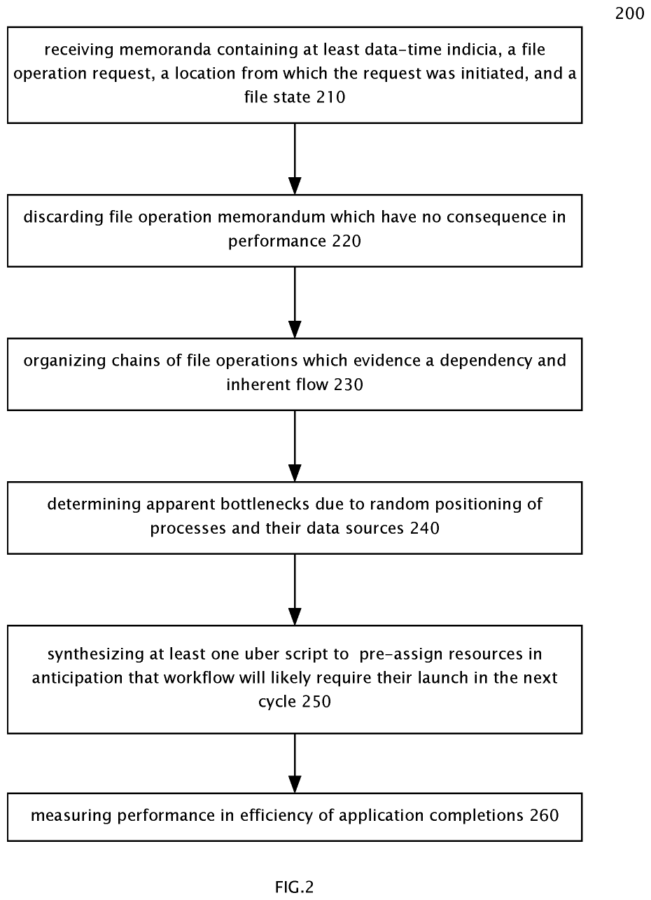

Another aspect of the invention is shown in FIG. 2, which includes a method at a preconfiguration apparatus coupled to a network of version control file managers having at least the processes: receiving memoranda containing at least data-time indicia, a file operation request, a location from which the request was initiated, and a file state 210; discarding file operation memorandum which have no consequence in performance 220; organizing chains of file operations which evidence a dependency and inherent flow 230; determining apparent bottlenecks due to random positioning of processes and their data sources 240; synthesizing at least one uber script to pre-assign resources in anticipation that workflow will likely require their launch in the next cycle 250; and measuring performance in efficiency of application completions 260.

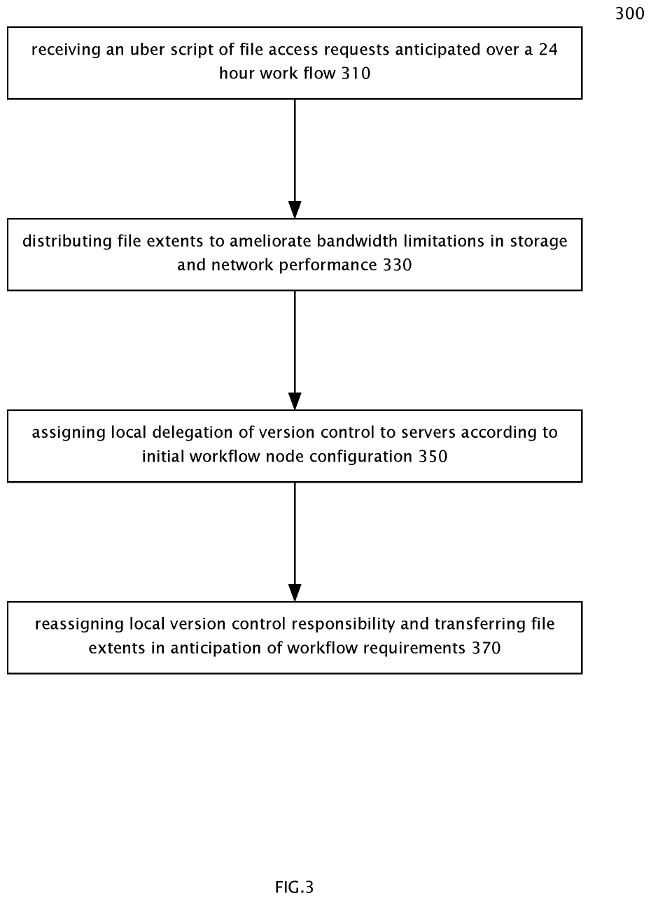

Another aspect of the invention is illustrated in FIG. 3 for a version control system, a method 300 includes: receiving an uber script of file access requests anticipated over a 24 hour work flow 310; distributing file extents to ameliorate bandwidth limitations in storage and network performance 330; assigning local delegation of version control to servers according to initial workflow node configuration 350; and reassigning local version control responsibility and transferring file extents in anticipation of workflow requirements 370.

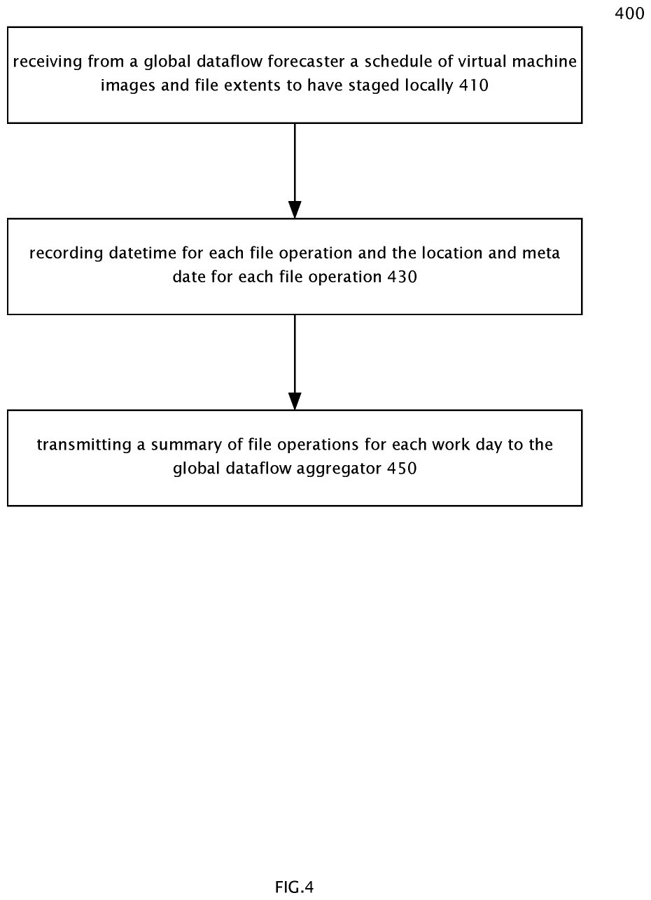

FIG. 4 illustrates a method of operation at each regional peer manager 400 including: receiving from a global dataflow forecaster a schedule of virtual machine images and file extents to have staged locally 410; recording datetime for each file operation and the location and meta date for each file operation 430; and transmitting a summary of file operations for each work day to the global dataflow aggregator 450.

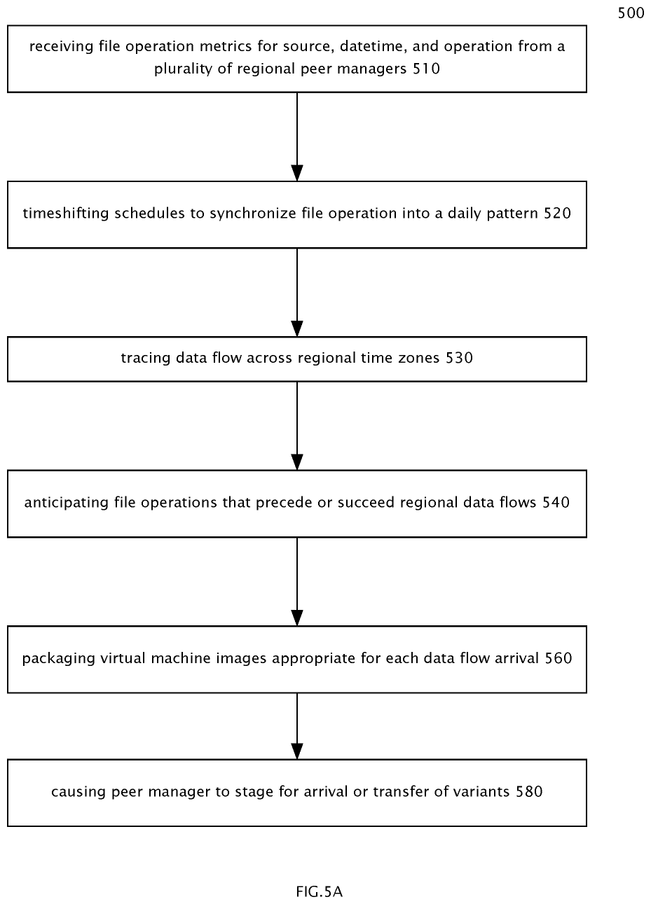

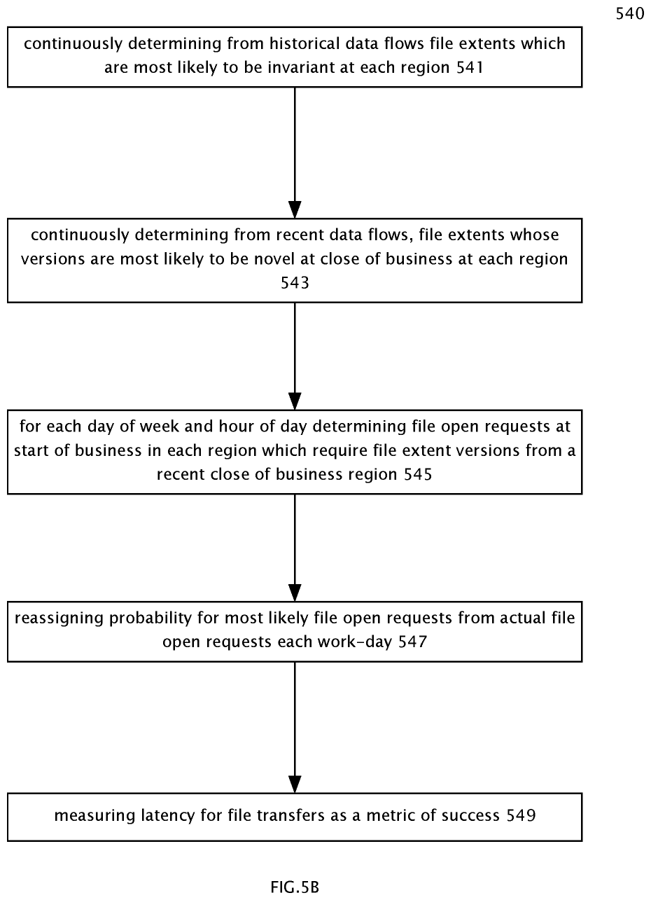

In FIG. 5A is illustrated a method of operation at a global dataflow aggregator coupled to a plurality of peer managers, is a process 500 including: receiving file operation metrics for source, datetime, and operation from a plurality of regional peer managers 510; timeshifting schedules to synchronize file operation into a daily pattern 520; and tracing data flow across regional time zones 530.

In an embodiment, the method also includes anticipating local file operations that precede or succeed regional data flows 540; packaging virtual machine images appropriate for each data flow arrival 560; and causing each peer manager to stage for each daily arrival or transfer of variants 580.

In an embodiment illustrated in FIG. 5B, anticipating local file operations that precede or succeed regional data flows 540 includes, continuously determining from historical data flows file extents which are most likely to be invariant at each region 541, continuously determining from recent data flows, file extents whose versions are most likely to be novel at close of business at each region 543, for each day of week and hour of day determining file open requests at start of business in each region which require file extent versions from a recent close of business region 545, reassigning probability for most likely file open requests from actual file open requests each work-day 547, and measuring latency for file transfers as a metric of success 549.

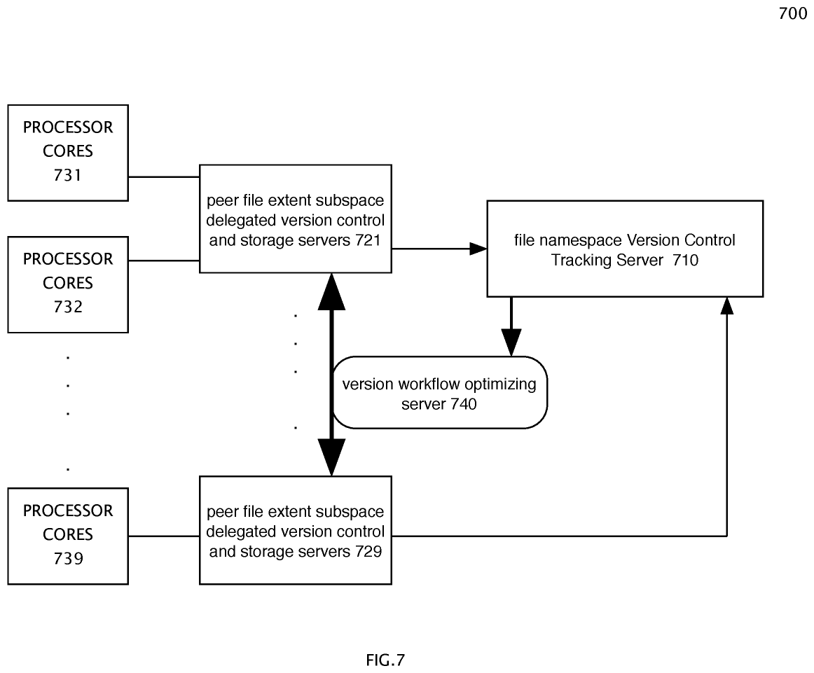

FIG. 7 illustrates an exemplary reconfigurable version control system 700 having: at least one file namespace Version Control Tracking Server 710; a plurality of peer file extent subspace delegated version control and storage servers 721-729; a plurality of instantiated processor cores 731-739; and a version workflow optimizing server 740. In this non-limiting embodiment, messages of all file operations reported by the version control servers are accumulated and transformed into an optimized uber script for pre-configuring the version control system for a subsequent workflow cycle.

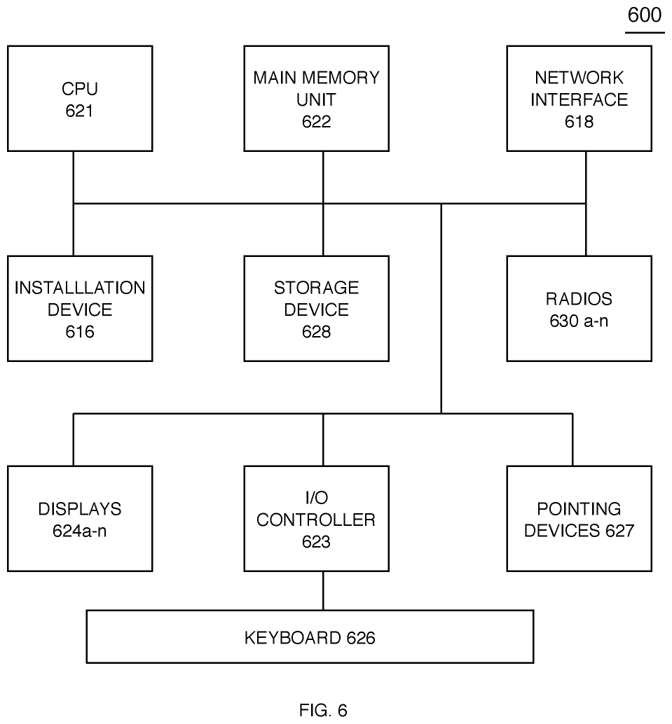

FIG. 6 is a block diagram of an exemplary processor 600 configured by computer executable instructions encoded in non-transitory media to perform the steps, transformations, and decision processes of a method embodiment of the invention.

Aspects of the invention can be appreciated as methods, apparatuses, and systems combining such methods and apparatuses.

For example, an application may write out intermediate results and logs for use in problem identification when the application abnormally fails. An additional script may eliminate these breadcrumbs when the desired result is obtained. So these files are not useful for furthering the project except when testing changes to the methodology. These files are frequently opened and closed during a development cycle and seldom consulted and frequently deleted in production. Write once, read hardly ever.

### CONCLUSION

The invention can easily be distinguished from conventional Most Recently Used (MRU) or Least Recently Used (LRU) wives tales on system performance optimization. Systems that optimize to MRU or LRU goals are belief driven rather than data driven. Conventional systems fail to disclose process flow of file operation messages to optimize peer configuration and required resources. Peers represent trackers and regional peer managers. Peers send messages to a Virtual Dataflow Aggregator Apparatus (VDA). Message represents each file operation and contains timestamp, peer interactions IDs, number of bytes in operation (in case of read/write operations), etc. All messages are sent to VDA. In an embodiment, multiple VDAs are used to process messages from all peers. Based on file operation types, timestamps, peer IDs and other information the system dynamically discovers which peers are very busy depending on day time, users, running projects, etc. and consequently require configuration and resource distribution changes to reduce latency. VDA sends messages to machine learning (ML) computational block. ML block based on previous model training results and new data applies heuristics to optimize peer configuration and resources to resolve bottlenecks and improve performance. As a result, ML generate a new peer configuration and updates existing configuration and resources. Each peer configuration is scored for efficiency and iterates its own heuristics. VDA may filter out messages by file operations according to ML block requests. This filter may be updated dynamically. The spacetime relationship of files is at least one of the most useful quantities. The kinds of operations are another dimension and can go a long way to warp the spacetime to its most useful set. For example a file that is continually being created and destroyed is probably not worth transmitting. On the other hand, file types of various file extents may be observed to be repeatably opened at locations distant from their commit location. A heuristic can pre-position them and be rewarded when these file extents are opened where predicted or deprecated if not required within a time budget. It can be appreciated that dynamic creation, tracking, and movement of file extents, e.g. a file block of variable size, is inherently automated within file system and version control and not accessible for mental or paper-based data management.

As is known, circuits disclosed above may be embodied by programmable logic, field programmable gate arrays, mask programmable gate arrays, standard cells, and computing devices limited by methods stored as instructions in non-transitory media.

Generally a computing devices 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device.

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments, the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; or Alphabet of Mountain View Calif. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

It should be understood that the systems described above may provide multiple ones of any or each of those components and these components may be provided on either a standalone machine or, in some embodiments, on multiple machines in a distributed system. The phrases in one embodiment’, in another embodiment’, and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for video surveillance, it will now become apparent to one of skill in the art that other embodiments incorporating the concepts of the disclosure may be used. Therefore, the disclosure should not be limited to certain embodiments, but rather should be limited only by the spirit and scope of the following claims.

We claim:

1. A method of optimizing performance among a plurality of servers networked to storage apparatuses comprising the steps:
loading file elements into economically suitable storage by anticipated performance requirements;
pre-configuring processors to respond promptly to requests from dynamically launched applications;
binding data stores and processors in network propinquity to reflect affinity of interactivity; and
receiving file-open and file-close memorandum from a workspace control system having sub-file access method granularity on invariant file elements to match with historical patterns of global work flow across timezones.

2. A method at a preconfiguration apparatus coupled to a network of version control file managers comprising processes:
receiving memoranda containing at least data-time indicia, a file operation request, a location from which the request was initiated, and a file state;
discarding file operation memorandum which have no consequence in performance;
organizing chains of file operations which evidence a dependency and inherent flow;
determining apparent bottlenecks due to random positioning of processes and their data sources;
synthesizing at least one uber script to pre-assign resources in anticipation that workflow will likely require their launch in the next cycle; and
measuring performance in efficiency of application completions.

3. At a version control system, a method comprising:
receiving an uber script of file access requests anticipated over a 24 hour work flow;
distributing file extents to ameliorate bandwidth limitations in storage and network performance;
assigning local delegation of version control to servers according to initial workflow node configuration; and
reassigning local version control responsibility and transferring file extents in anticipation of workflow requirements.

4. A method of operation at each regional peer manager comprising:
receiving from a global dataflow forecaster a schedule of virtual machine images and file extents to have staged locally;
recording datetime for each file operation and the location and meta date for each file operation; and
transmitting a summary of file operations for each work day to the global dataflow aggregator.

5. At a global dataflow aggregator coupled to a plurality of peer managers, a method of operation comprising:
receiving file operation metrics for source, datetime, and operation from a plurality of regional peer managers;
timeshifting schedules to synchronize file operation into a daily pattern; and
tracing data flow across regional time zones;
anticipating local file operations that precede or succeed regional data flows;
packaging virtual machine images appropriate for each data flow arrival; and
causing each peer manager to stage for each daily arrival or transfer of variants.

6. The method of claim 5 further comprising:
anticipating local file operations that precede or succeed regional data flows;
packaging virtual machine images appropriate for each data flow arrival; and
causing each peer manager to stage for each daily arrival or transfer of variants, wherein anticipating local file operations that precede or succeed regional data flows comprises, continuously determining from historical data flows file extents which are most likely to be invariant at each region, continuously determining from recent data flows, file extents whose versions are most likely to be novel at close of business at each region, for each day of week and hour of day determining file open requests at start of business in each region which require file extent versions from a recent close of business region, reassigning probability for most likely file open requests from actual file open requests each work-day, and measuring latency for file transfers as a metric of success.

7. A reconfigurable version control system comprising:
at least one file namespace Version Control Tracking Server;
a plurality of peer file extent subspace delegated version control and storage servers;
a plurality of instantiated processor cores; and
a version workflow optimizing server, whereby messages of all file operations reported by the version control servers are accumulated and transformed into an optimized uber script for pre-configuring the version control system for a subsequent workflow cycle.
